(19) United States
(12) Patent Application Publication
(10) Pub. No.: US 2025/0102621 A1
(43) Pub. Date: Mar. 27, 2025

(54) RADAR SENSOR

(71) Applicant: KaiKuTek INC., Taipei (TW)

(72) Inventors: Mike Chun-Hung Wang, Taipei (TW); Yi-Chu Chen, Taipei (TW); Tun-Yen Liao, Taipei (TW); Yi-Ting Tseng, Taipei (TW); Wei-Chi Li, Taipei (TW)

(73) Assignee: KaiKuTek INC., Taipei (TW)

(21) Appl. No.: 18/629,883

(22) Filed: Apr. 8, 2024

Related U.S. Application Data
(60) Provisional application No. 63/540,667, filed on Sep. 27, 2023.

(51) Int. Cl. G01S 7/35; G01S 7/02; G01S 7/40; G01S 13/32

(52) U.S. Cl. CPC G01S 7/35; G01S 7/023; G01S 7/4056; G01S 13/32

(57) ABSTRACT

In a radar sensor, a transmitting antenna is configured to radiate a transmitted RF signal, a receiving antenna is configured to receive a reflected RF signal from a target, and a frontend circuit is configured to calculate the distance between the target and the radar sensor by measuring the frequency shift between the transmitted RF signal and the reflected RF signal. The frontend circuit includes a crystal-less signal synthesizer configured to generate the transmitted RF signal without using a crystal, and a mixer configured to provide an IF-band signal associated with the frequency shift between the transmitted RF signal and the reflected RF signal by mixing the reflected RF signal and the transmitted RF signal.

### CROSS REFERENCE TO RELATED APPLICATIONS

This application claims the benefit of U.S. Provisional Application No. 63/540,667, filed on Sep. 27, 2023. The content of the application is incorporated herein by reference.

### BACKGROUND OF THE INVENTION

### 1. Field of the Invention

The present invention is related to a radar sensor, and more particularly, to an FMCW radar sensor which adopts a crystal-less signal synthesizer configured to generate a frequency-modulated transmitted radio frequency signal without using any crystal oscillator.

### 2. Description of the Prior Art

Radar systems use radio waves to detect objects in the environment. It allows determining the distance (known as range), angular position (bearing) and velocity. Several radar types exist, including the continuous wave (CW) radars, frequency-modulated continuous wave (FMCW) radars, and pulsed radars. These radars are widely employed in Internet of Things (IoT) applications because they do not require high computing power and data acquisition devices.

In an FMCW radar system, the transmitting antenna emits frequency modulated continuous radio frequency (RF) signal, and the reflected RF signal from an object is received by the receiving antenna. The output of the receiving antenna is given to the mixer stage of the receiver via a pre-amplifier. In the mixer circuit, a part of the frequency-modulated transmitted signal is mixed with the received signal, producing a new signal which can be used to determine the distance and/or velocity of the moving object. The frequency of the new signal is associated with the difference between the frequency of the transmitted and received (reflected) signal. The FMCW radar possesses a simple and low-complexity architecture. Furthermore, it can simultaneously detect the speed and distance of objects with high accuracy. Common applications of FMCW radars include active electronically scanned array (AESA) systems, advanced driver assistance systems (ADAS) and multi-hand gesture recognition systems.

At the core of a radar system lies its ability to generate, transmit, and receive RF signals with unparalleled accuracy and stability. A crystal oscillator is an electronic oscillator circuit that uses a piezoelectric crystal as a frequency-selective element in order to provide precise and stable clock signals for digital, analog and RF integrated circuits. With the capability of providing precise timing and frequency controls, crystal oscillators are widely used in existing FMCW radars as reference frequency source. However, for short-range FMCW applications with larger tolerance in frequency errors, highly precise, temperature-compensated, or oven-controlled crystal oscillators may be too expensive.

### SUMMARY OF THE INVENTION

The present invention provides a radar sensor which includes at least one transmitting antenna, at least one receiving antenna and a frontend circuit. The transmitting antenna is configured to radiate a transmitted RF signal. The receiving antenna is configured to receive a reflected RF signal from a target. The frontend circuit is configured to calculate a distance between the target and the radar sensor by measuring a characteristic shift between the transmitted RF signal and the reflected RF signal. The frontend circuit includes a crystal-less signal synthesizer configured to generate the transmitted RF signal without using a crystal, and a mixer configured to provide an IF-band signal associated with the characteristic shift between the transmitted RF signal and the reflected RF signal by mixing the reflected RF signal and the transmitted RF signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram illustrating a radar sensor according to an embodiment of the present invention.

FIG. 2 is a diagram illustrating an implantation of an RF frontend circuit in a radar sensor according to an embodiment of the present invention.

FIG. 3 is a diagram illustrating an implantation of an RF frontend circuit in a radar sensor according to another embodiment of the present invention.

FIG. 4 is a functional diagram illustrating a radar sensor according to another embodiment of the present invention.

FIG. 5 is a functional diagram illustrating a crystal-less signal synthesizer in an RF frontend circuit of a radar sensor according to an embodiment of the present invention.

FIG. 6 is a diagram illustrating an implementation of a reference clock in a crystal-less signal synthesizer according to an embodiment of the present invention.

FIGS. 7A-7B are diagrams illustrating implementations of a reference clock in a crystal-less signal synthesizer according to other embodiments of the present invention.

FIG. 7C is a diagram illustrating an implementation of each amplifier in the reference clock depicted in FIGS. 6A-6B according to an embodiment of the present invention.

FIG. 8 is a diagram illustrating an implementation of a reference clock in a crystal-less signal synthesizer according to another embodiment of the present invention.

### DETAILED DESCRIPTION

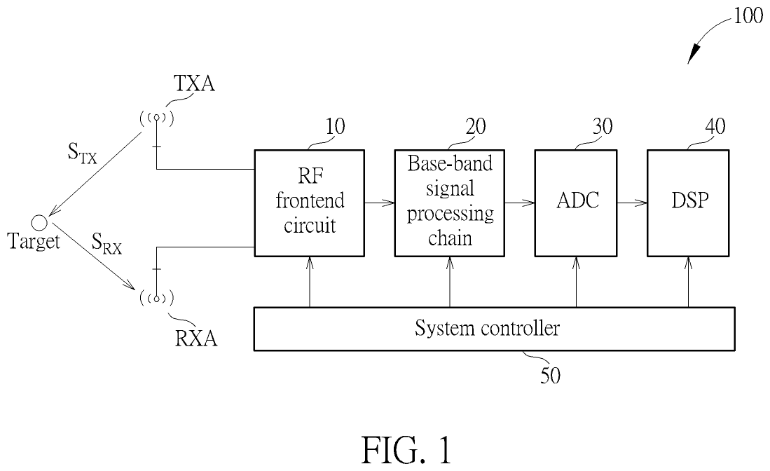

FIG. 1 is a functional diagram illustrating a radar sensor 100 according to an embodiment of the present invention. The radar sensor 100 includes at least a transmitting antenna (TX antenna) TXA, a receiving antenna (RX antenna) RXA, an RF frontend circuit 10, a base-band signal processing chain 20, an analog-to-digital converter (ADC) 30, a digital signal processor (DSP) 40, and a system controller 50.

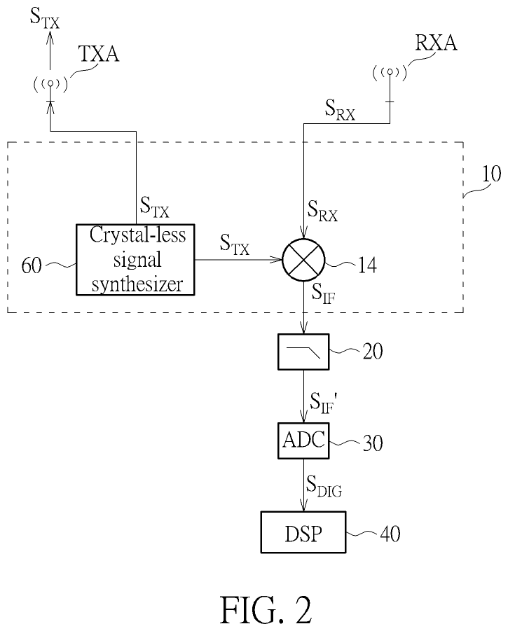

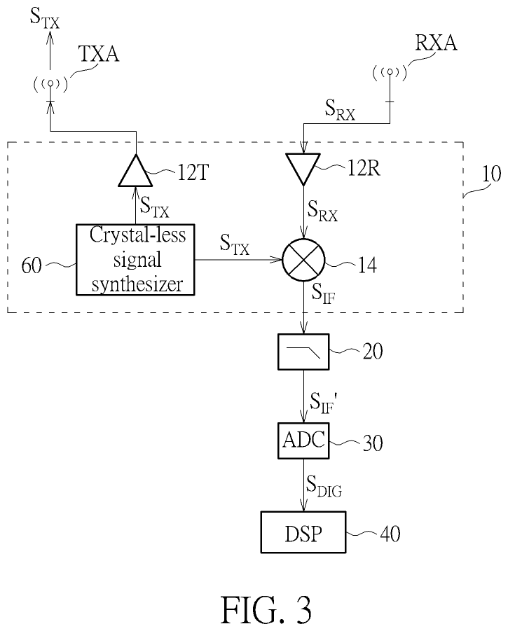

FIG. 2 is a diagram illustrating an implantation of the RF frontend circuit 10 according to an embodiment of the present invention. FIG. 3 is a diagram illustrating an implantation of the RF frontend circuit 10 according to another embodiment of the present invention. In the embodiments depicted in FIGS. 2 and 3, the RF frontend circuit 10 includes at least a mixer 14 and a crystal-less signal synthesizer 60. In the embodiment depicted in FIG. 3, the RF frontend circuit 10 further includes amplifiers 12T and 12R, a mixer 14 and a crystal-less signal synthesizer 60. In an embodiment, the amplifier 12T is a power amplifier (PA) coupled between the transmitting antenna TXA and the crystal-less signal synthesizer 60, and the amplifier 12R is a low-noise amplifier (LNA) coupled between the receiving antenna RXA and the mixer 14. However, the types of the amplifiers 12T and 12R do not limit the scope of the present invention.

The crystal-less signal synthesizer 60 is configured to generate a frequency-modulated transmitted RF signal S_{TX} at a known rate over a fixed time period without using any crystal oscillator. In the present invention, the crystal-less signal synthesizer 60 may change the frequency pattern of the transmitted RF signal S_{TX} using a variety of frequency modulation techniques, such as saw-tooth modulation, triangular modulation, sine wave modulation, square wave modulation, and stepped modulation, thereby giving the transmitted RF signal S_{TX} a “time stamp”. However, the type of frequency modulation technique adopted by the crystal-less signal synthesizer 60 does not limit the scope of the present invention.

Next, the transmitted RF signal S_{TX} is radiated via the transmitting antenna TXA, as depicted in FIG. 2. Alternatively, the transmitted RF signal S_{TX} is first amplified by the RF amplifier 12T, and the amplified transmitted RF signal S_{TX} is radiated via the transmitting antenna TXA, as depicted in FIG. 3. If the transmitted RF signal S_{TX} reaches a target in the environment, the reflected RF signal S_{TX} from the target is received via the receiving antenna RXA and then optionally amplified by the amplifier 12R (FIG. 3). The mixer 14 is coupled to the receiving antenna RXA for directly receiving the reflected RF signal S_{RX} (FIG. 2), or coupled to the RF amplifier 12R for receiving the amplified reflected RF signal S_{RX} (FIG. 3). The mixer 14 is also coupled to the crystal-less signal synthesizer 60 for receiving the transmitted RF signal S_{TX}. The mixer 14 is configured to down-covert the reflected RF signal S_{RX} by mixing the reflected RF signal S_{RX} and the transmitted RF signal S_{TX}, thereby providing an intermediate frequency band (IF-band) signal S_{IF}. In the embodiments depicted in FIGS. 2 and 3, the above-mentioned down-conversion is accomplished in one step by one mixer 14. Alternatively in another embodiment of the present invention, down-conversion may also be accomplished in two or more steps using two or more mixers connected in series. However, the implementation of the mixer stage in the RF frontend circuit 10 does not limit the scope of the present invention.

The base-band signal processing chain 20 is coupled to the mixer 14 for receiving the IF-band signals S_{IF}, and is configured to suppress undesired sidebands or image frequencies in the IF-band signals S_{IF} by analog base band signals processing, thereby providing filtered IF-band signals S_{IF}′. The ADC 30 is coupled to the base-band signal processing chain 20 for receiving the filtered IF-band signals S_{IF}′, and is configured to convert the filtered IF-band signals S_{IF}′ into a digital signal S_{DIG}. The DSP 40 is configured to process the filtered IF-band signals S_{IF}′ in the digital domain for providing a feature map associated with the characteristic shift between the reflected RF signal S_{RX} and the transmitted RF signal S_{TX}. In an embodiment, the characteristic shift includes the frequency shift, the phase shift and/or the magnitude shift between the transmitted RF signal S_{TX} and the reflected RF signal S_{RX}.

In an embodiment, the radar sensor 100 is an FMCW radar system which measures the frequency shift between the transmitted RF signals S_{TX} and the reflected RF signals S_{RX} for calculating the distance and the speed of the target. In the FMCW technique, the frequency of the transmitted RF signal S_{TX} differs from the frequency of the reflected RF signal S_{RX} by an amount Δf due to the run time delay between the transmitted and received signals. The mixer 14 of the RF frontend circuit 10 is configured to acquire the frequency shift Δf associated with the IF-band signals S_{IF} by mixing the reflected RF signal S_{RX} and the transmitted RF signals S_{TX}. This frequency shift Δf is proportional to the distance between the target and the radar sensor 100. If the reflected RF signal S_{RX} is monitored over several periods, an additional frequency shift fD may be observed as the target moving towards or away from the radar sensor 100, due to the Doppler effect. This allows for determining the velocity of the target. In addition, if the radar sensor 100 includes several spatially distributed transmitting antennas TXA and receiving antennas RXA, the direction of arrival of several reflected RF signals S_{RX} may be established for obtaining multi-dimensional positions of the target. The operating principle of an FMCW radar and related formula are well-known in this art and thus will not be further discussed herein.

In an embodiment, the DSP 40 may perform one-dimensional (1D) or multi-dimensional fast Fourier transform (FFT) for converting the digital signal S_{DIG} from its time domain to a representation in the frequency domain, thereby constructing the feature map associated with the frequency shift between the reflected RF signal S_{RX} and the transmitted RF signal S_{TX}. In the 1D application, the location of a peak in the frequency spectrum of the digital signal S_{DIG} directly corresponds to the range of the target. In the two-dimensional (2D) application, the DSP 40 may perform two-dimensional fast Fourier transform (2D-FFT) on multiple reflected RF signals S_{RX} associated with a 2D complex matrix to estimate the range and Doppler map (RDM) of the target. In the three-dimensional (3D) application, the DSP 40 may perform three-dimensional fast Fourier transform (3D-FFT) on multiple reflected RF signals S_{RX} associated with a 3D data along each dimensional to estimate the range, the RDM and the range-angle map (RAM) of the target. However, the operation principle of the DSP 40 does not limit the scope of the present invention.

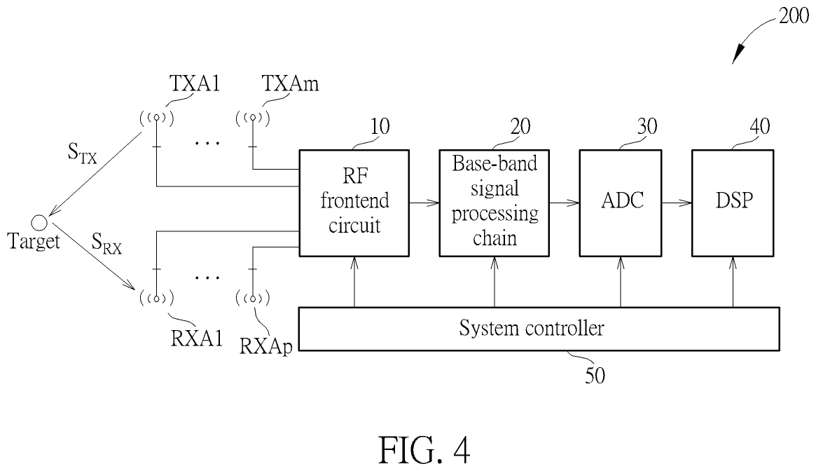

FIG. 4 is a functional diagram illustrating a radar sensor 200 according to another embodiment of the present invention. The radar sensor 200 includes at least a plurality of TX antennas TXA1-TXAm, a plurality of RX antennas RXA1-RXAp, an RF frontend circuit 10, a base-band signal processing chain 20, an ADC 30, a DSP 40, and a system controller 50, wherein m and p are integers larger than 1.

In the radar sensor 200 depicted in FIG. 4, the RF frontend circuit 10 may include a plurality of amplifiers 12T, a plurality of amplifiers 12R, a plurality of mixers 14 and a plurality of crystal-less signal synthesizers 60 with the similar structures and functions as depicted in FIG. 2 or FIG. 3. In an embodiment, each amplifier 12T is a power amplifier coupled between a corresponding transmitting antenna and a corresponding crystal-less signal synthesizer 60, and each amplifier 12R may be a low-noise amplifier coupled between a corresponding receiving antenna RXA and a corresponding mixer 14. However, the types of the amplifiers 12T and 12R do not limit the scope of the present invention.

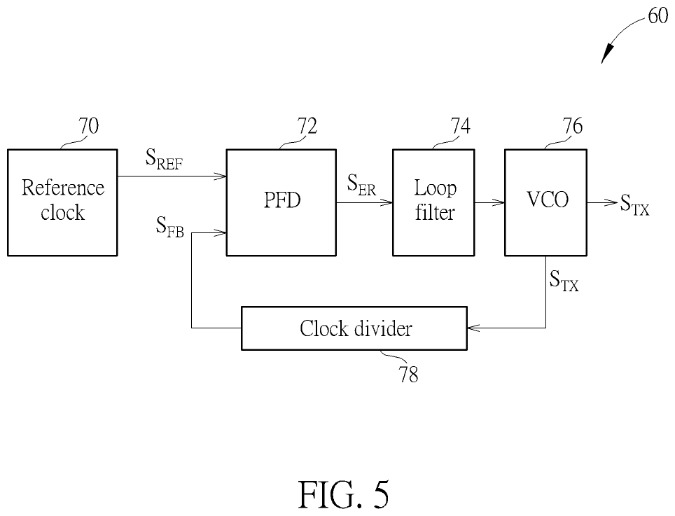

FIG. 5 is a functional diagram illustrating the crystal-less signal synthesizer 60 in the RF frontend circuit 10 according to an embodiment of the present invention. The crystal-less signal synthesizer 60 is implemented as a phase locked loop (PLL) which includes a reference clock 70, a phase frequency detector (PFD) 72, a loop filter 74, a voltage-controlled oscillator (VCO) 76 and a clock divider 78. The reference clock 70 is configured to generate a reference signal S_{REF} of a specific frequency without using any crystal. The PFD 72 is configured to compare the phase of the reference signal S_{REF} with the phase of a feedback signal S_{FB} which is associated with the transmitted RF signal S_{TX} fed back from the output of the VCO 76 via the clock divider 78, thereby producing an error signal S_{ER} proportional to the phase difference between the reference signal S_{REF} and the feedback signal S_{FB}. The loop filter 74 is configured to remove the higher-frequency components of the error signal S_{ER}, which drives the VCO 76. The VCO 76 is configured to generate the transmitted RF signal S_{TX} according to the error signal S_{ER} so that the transmitted RF signal S_{TX} has a fixed relationship to the reference signal S_{REF}. The clock divider 76 is coupled between the output of the VCO 76 and the input of the PFD 72, and configured to generate the feedback signal S_{FB} according to the transmitted RF signal S_{TX}, thereby producing a negative feedback loop.

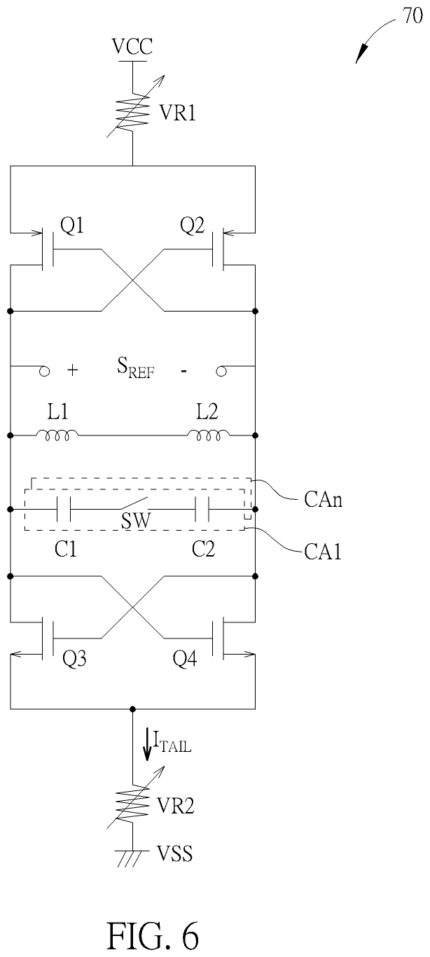

FIG. 6 is a diagram illustrating an implementation of the reference clock 70 in the crystal-less signal synthesizer 60 according to an embodiment of the present invention. In the embodiment depicted in FIG. 6, the reference clock 70 is implemented with an LC oscillator which includes variable resistors VR1-VR2, inductors L1-L2, capacitor arrays CA1-CAn, and transistors Q1-Q4 disposed in a cross-coupled manner, wherein n is an integer larger than 2. In the embodiment depicted in FIG. 6, the transistors Q1-Q2 are P-type metal-oxide-semiconductor field-effect transistors (MOSFET) and the transistors Q3-Q4 are N-type MOSFETs. However, the types of the transistors Q1-Q4 do not limit the scope of the present invention.

In the embodiment depicted in FIG. 6, the reference clock 70 implemented with an LC oscillator is configured to output the reference signal S_{REF} at a first output end (designated by “+”) and a second output end (designated by “−”). The variable resistor VR1 includes a first end coupled to a bias voltage VCC and a second end coupled to the transistors Q1-Q2. The variable resistor VR2 includes a first end coupled to the transistors Q3-Q4 and a second end coupled to a bias voltage VSS. The transistor Q1 includes a first end coupled to the second end of the variable resistor VR1, a second end coupled to the first output end of the reference clock 70, and a control end coupled to the second output end of the reference clock 70. The transistor Q2 includes a first end coupled to the second end of the variable resistor VR1, a second end coupled to the control end of the transistor Q1, and a control end coupled to the second end of the transistor Q1. The transistor Q3 includes a first end coupled to the second end of the transistor Q1, a second end coupled to the first end of the variable resistor VR2, and a control end coupled to the second end of the transistor Q2. The transistor Q4 includes a first end coupled to the control end of the transistor Q3, a second end coupled to the first end of the variable resistor VR2, and a control end coupled to the first end of the transistor Q3. The inductors L1 and L2 are coupled in series between the second end of the transistor Q1 and the second end of the transistor Q2. Each of the capacitor arrays CA1-CAn is coupled between the second end of the transistor Q1 and the second end of the transistor Q2.

In the reference clock 70 depicted in FIG. 6, the inductors L1 and L2 and the capacitor arrays CA1-CAn form a LC tank resonator. The double cross-coupled P-type transistors Q1-Q2 and N-type transistors Q3-Q4 differential pairs provide the negative resistance to compensate the tank loss, thereby providing better quality factor. The oscillation frequency range of the reference signal S_{REF} may be controlled by the capacitor arrays CA1-CAn, each of which includes at least capacitors C1-C2 and a switch SW. By selectively turning on or turning off the switch SW in each capacitor array, the capacitance per unit area of the LC tank resonator may be adjusted for varying the oscillation frequency range of the reference signal S_{REF}.

In the reference clock 70 depicted in FIG. 6, the variable resistor VR1 disposed on the side of the bias voltage VCC and the variable resistor VR2 disposed on the side of the bias voltage VSS provide a tail current-shaping scheme for increasing the amplitude of the reference signal S_{REF} and reducing the phase noise. In an embodiment, by adjusting the resistance of the variable resistors VR1-VR2, the tail current I_{TAIL} flowing through the reference clock 70 may be made large when the reference signal S_{REF} reaches its maximum or minimum value and when the sensitivity of the output phase to injected noise is the smallest; the tail current I_{TAIL} may be made small during the zero crossings of the reference signal S_{REF} When the phase noise sensitivity is large.

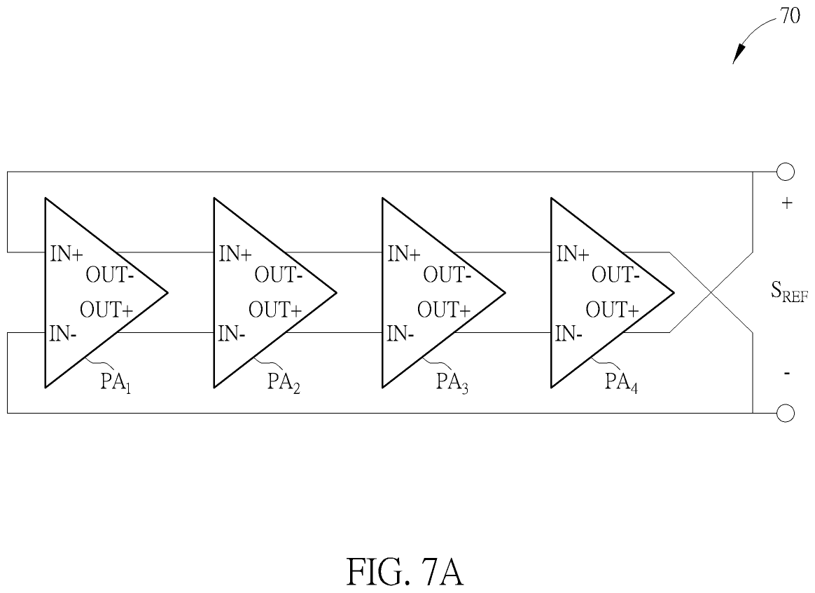

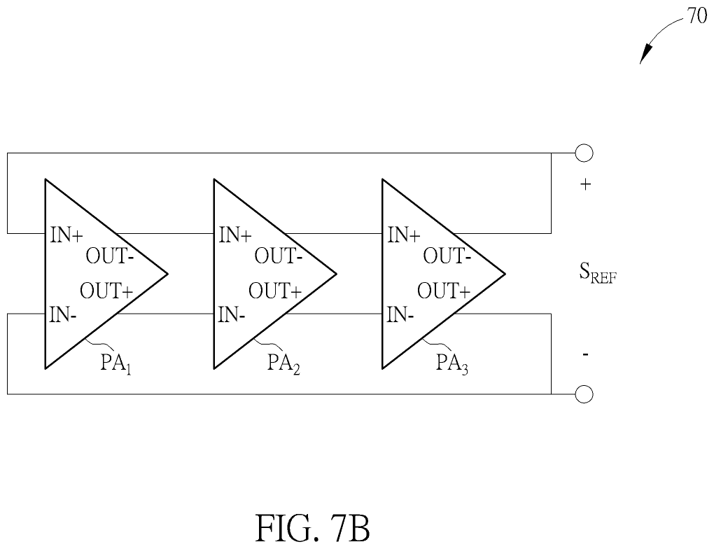

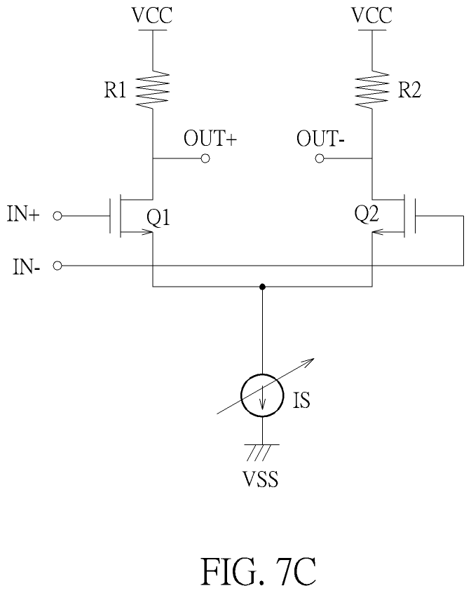

FIGS. 7A-7B are diagrams illustrating implementations of the reference clock 70 in the crystal-less signal synthesizer 60 according to other embodiments of the present invention. In the embodiments depicted in FIGS. 7A and 7B, the reference clock 70 is implemented using a ring oscillator which includes M amplifiers PA₁-PA_{M}, wherein M is an integer larger than 1. The amplifiers PA₁-PA_{M} are coupled in series, with the output signals of the last-stage amplifier PA_{M} being fed back to the input of the first-stage amplifier PA₁.

FIG. 7C is a diagram illustrating an implementation of each amplifier in the reference clock 70 depicted in FIGS. 7A-7B according to an embodiment of the present invention. Each amplifier in the reference clock 70 depicted in FIG. 7A or FIG. 7B includes a positive input end IN+, a negative input end IN−, a positive output end OUT+, a negative output end OUT−, resistors R1-R2, transistors Q1-Q2, and a variable current source IS. In the embodiment depicted in FIG. 7C, the transistors Q1-Q2 are N-type MOSFETs, but are not limited thereto.

In the embodiment when M is an even integer, the positive output end OUT+ and the negative output end OUT− of the amplifier PAₘ among the M amplifiers PA₁-PA_{M} are respectively coupled to the negative input end IN− and the positive input end IN+ of the amplifier PAₘ₊₁ when m is a positive integer smaller than M, while the positive output end OUT+ and the negative output end OUT− of the last-stage amplifier PA_{M} are respectively coupled to the positive input end IN+ and the negative input end IN+ of the first-stage amplifier PA₁. For illustrative purpose, FIG. 7A depicts the embodiment of M=4. However, the number of the amplifiers in the ring oscillator does not limit the scope of the present invention.

In the embodiment when M is an odd integer, the positive output end OUT+ and the negative output end OUT− of the amplifier PAₘ among the M amplifiers PA₁-PA_{M} are respectively coupled to the negative input end IN− and the positive input end IN+ of the amplifier PAₘ₊₁ when m is a positive integer smaller than M, while the positive output end OUT+ and the negative output end OUT− of the last-stage amplifier PA_{M} are respectively coupled to the negative input end IN− and the positive input end IN+ of the first-stage amplifier PA₁. For illustrative purpose, FIG. 7B depicts the embodiment of M=3. However, the number of the amplifiers in the ring oscillator does not limit the scope of the present invention.

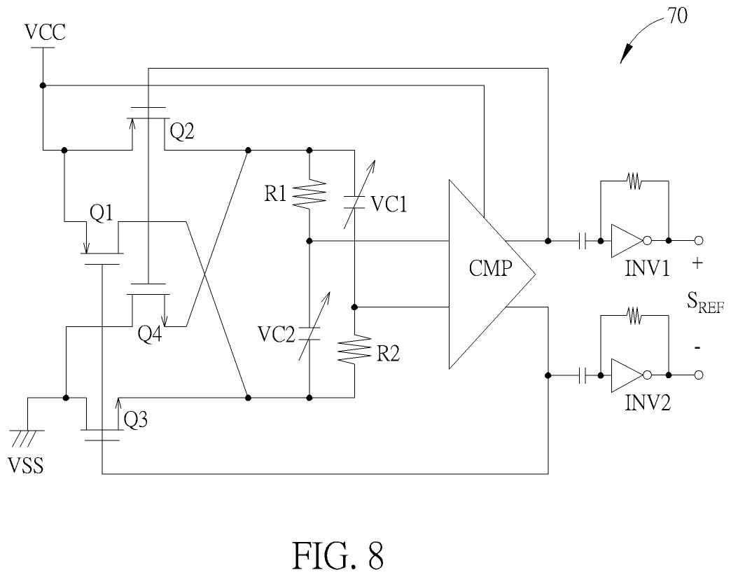

FIG. 8 is a diagram illustrating an implementation of the reference clock 70 in the crystal-less signal synthesizer 60 according to another embodiment of the present invention. In the embodiment depicted in FIG. 8, the reference clock 70 is implemented with an RC oscillator which includes resistors R1-R2, variable capacitors VC1-VC2, a comparator CMP, inverters INV1-INV2 and transistors Q1-Q4 disposed in a cross-coupled manner. In the embodiment depicted in FIG. 8, the transistors Q1-Q2 are P-type MOSFETs and the transistors Q3-Q4 are N-type MOSFETs. However, the types of the transistors Q1-Q4 do not limit the scope of the present invention.

In the embodiment depicted in FIG. 8, the reference clock 70 implemented with an RC oscillator is configured to output the reference signal S_{REF} at a first output end (designated by “+”) and a second output end (designated by “−”). The transistor Q1 includes a first end coupled to a bias voltage VCC, a second end and a control end. The transistor Q2 includes a first end coupled to the bias voltage VCC, a second end and a control end. The transistor Q3 includes a first end coupled to the second end of the transistor Q1, a second end coupled to a bias voltage VSS, and a control end coupled to the control end of the transistor Q1. The transistor Q4 includes a first end coupled to the second end of the transistor Q2, a second end coupled to the bias voltage VSS, and a control end coupled to the control end of the transistor Q2. The comparator CMP includes a first input end, a second input end, a first output end coupled to the control ends of the transistors Q2 and Q4, and a second output end coupled to the control ends of the transistors Q1 and Q3. The resistor includes a first end coupled to the second end of the transistor Q1 and a second end coupled to the first input end of the comparator CMP. The resistor R2 includes a first end coupled to the second input end of the comparator CMP, and a second end coupled to the first end of the transistor Q3. The variable capacitor VC1 includes a first end coupled to the second end of the transistor Q2, and a second end coupled to the second input end of the comparator CMP. The variable capacitor VC2 includes a first end coupled to the first input end of the comparator CMP, and a second end coupled to the first end of the transistor Q3. The inverter INV1 is coupled between the first output end of the comparator CMP and the first output end of the reference clock 70. The inverter INV2 is coupled between the second output end of the comparator CMP and the second output end of the reference clock 70.

In the reference clock 70 depicted in FIG. 8, the resistors R1-R2 and the variable capacitors VC1-VC2 form an RC tank resonator. The double cross-coupled P-type transistors Q1-Q2 and N-type transistors Q3-Q4 differential pairs provide the negative resistance to compensate the tank loss, thereby providing better quality factor. The oscillation frequency range of the reference signal S_{REF} may be controlled by adjusting the capacitance of the variable capacitors VC1-VC2 so as to adjust the capacitance per unit area of the RC tank resonator, thereby varying the oscillation frequency range of the reference signal S_{TX}. The comparator CMP and the inverters INV1-INV2 provide an offset cancellation architecture for achieving long-term frequency stability and temperature stability while operating at lower power.

In conclusion, the present invention provides a radar sensor which adopts a crystal-less signal synthesizer configured to generate a frequency-modulated transmitted RF signal at a known rate over a fixed time period without using any crystal oscillator. The present radar sensor is particularly suitable for short-range FMCW applications with larger tolerance in frequency errors.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radar sensor, comprising:
at least one transmitting antenna configured to radiate a transmitted radio frequency (RF) signal;
at least one receiving antenna configured to receive a reflected RF signal from a target; and
a frontend circuit configured to calculate a distance between the target and the radar sensor by measuring a characteristic shift between the transmitted RF signal and the reflected RF signal, and comprising:
a crystal-less signal synthesizer configured to generate the transmitted RF signal without using a crystal; and
a mixer configured to provide an intermediate frequency (IF)-band signal associated with the characteristic shift between the transmitted RF signal and the reflected RF signal by mixing the reflected RF signal and the transmitted RF signal.

2. The radar sensor of claim 1, wherein the mixer is coupled to the at least one receiving antenna for receiving the reflected RF signal and coupled to the crystal-less signal synthesizer for receiving the transmitted RF signal.

3. The radar sensor of claim 2, wherein the frontend circuit further comprises:
a first amplifier coupled between the crystal-less signal synthesizer and the at least one transmitting antenna for amplifying the transmitted RF signal; and
a second amplifier coupled between the at least one receiving antenna and the mixer for amplifying the reflected RF signal.

4. The radar sensor of claim 1, further comprising:
a base-band signal processing chain configured to suppress an undesired sideband or an undesired frequency in the IF-band signal, thereby providing a filtered IF-band signal;
an analog-to-digital converter configured to convert the filtered IF-band signal into a digital signal; and
a digital signal processor configured to construct a feature map associated with the characteristic shift between the transmitted RF signal and the reflected RF signal based on the digital signal for calculating the distance between the target and the radar sensor.

5. The radar sensor of claim 4, wherein the characteristic shift includes a frequency shift, a phase shift and/or a magnitude shift between the transmitted RF signal and the reflected RF signal.

6. The radar sensor of claim 1, wherein the crystal-less signal synthesizer is implemented as a phase locked loop (PLL) which includes:
a reference clock configured to generate a reference signal of a specific frequency without using any crystal;
a phase frequency detector configured to compare a phase of the reference signal with a phase of a feedback signal which is associated with the transmitted RF signal, thereby producing an error signal proportional to a phase difference between the reference signal and the feedback signal;
a loop filter configured to remove a predetermined frequency component of the error signal;
a voltage-controlled oscillator (VCO) configured to generate the transmitted RF signal according to the error signal; and
a clock divider configured to generate the feedback signal according to the transmitted RF signal.

7. The radar sensor of claim 6, wherein the reference clock is implemented with an LC oscillator which comprises:
a first variable resistor including:
a first end coupled to a first bias voltage; and
a second end;
a second variable resistor including:
a first end; and
a second end coupled to a second bias voltage;
a first transistor including:
a first end coupled to the second end of the first variable resistor;
a second end; and
a control end;
a second transistor including:
a first end coupled to the second end of the first variable resistor;
a second end coupled to the control end of the first transistor; and
a control end coupled to the second end of the first transistor;
a third transistor including:
a first end coupled to the second end of the first transistor;
a second end coupled to the first end of the second variable resistor; and
a control end coupled to the second end of the second transistor;
a fourth transistor including:
a first end coupled to the control end of the third transistor;
a second end coupled to the first end of the second variable resistor; and
a control end coupled to the first end of the third transistor;
a first inductor and a second inductor coupled in series between the second end of the first transistor and the second end of the second transistor; and
a first capacitor array coupled between the second end of the first transistor and the second end of the second transistor.

8. The radar sensor of claim 7, wherein the reference clock further comprises:
a second capacitor array selectively coupled in parallel with the first capacitor array.

9. The radar sensor of claim 6, wherein the reference clock is implemented with a ring oscillator which comprises a first through an M^{th} amplifiers coupled in series, an output signal of the M^{th} amplifier is fed back to an input of the first amplifier, and M is an integer larger than 1.

10. The radar sensor of claim 9, wherein each amplifier in the reference clock comprises:
a positive input end and a negative input end;
a positive output end and a negative output end;
a first resistor including:
a first end coupled to a first bias voltage; and
a second end coupled to the positive output end;
a second resistor including:
a first end coupled to the first bias voltage; and
a second end coupled to the negative output end;
a first transistor including:
a first end coupled to the second end of the first resistor;
a second end; and
a control end coupled to the positive input end;
a second transistor including:
a first end coupled to the second end of the second resistor;
a second end coupled to the second end of the first transistor; and
a control end coupled to the negative input end; and
a variable current source including:
a first end coupled to the second end of the first transistor and the second end of the second transistor; and
a second end coupled to a second bias voltage.

11. The radar sensor of claim 9, wherein:
a positive output end and a negative output end of an m^{th} amplifier among the first through the M^{th} amplifiers are respectively coupled to a negative input end and a positive input end of an (m+1)^{th} amplifier among the first through the M^{th} amplifiers when m is a positive integer smaller than M;
a positive output end and a negative output end of the M^{th} amplifier are respectively coupled to a positive input end and a negative input end of the first amplifier; and
M is an even integer.

12. The radar sensor of claim 9, wherein:
a positive output end and a negative output end of an m^{th} amplifier among the first through the M^{th} amplifiers are respectively coupled to a negative input end and a positive input end of an (m+1)^{th} amplifier among the first through the M^{th} amplifiers when m is a positive integer smaller than M;
the positive output end and the negative output end of the M^{th} amplifier are respectively coupled to a negative input end and a positive input end of the first amplifier; and
M is an odd integer.

13. The radar sensor of claim 6, wherein the reference clock is implemented with an RC oscillator which comprises:
a first transistor including:
a first end coupled to a first bias voltage;
a second end; and
a control end;
a second transistor including:
a first end coupled to the first bias voltage;
a second end; and
a control end;
a third transistor including:
a first end coupled to the second end of the first transistor;
a second end coupled to a second bias voltage; and
a control end coupled to the control end of the first transistor;
a fourth transistor including:
a first end coupled to the second end of the second transistor;
a second end coupled to the second bias voltage; and
a control end coupled to the control end of the second transistor;
a comparator including:
a first input end;
a second input end;
a first output end coupled to the control end of the second transistor and the control end of the fourth transistor; and
a second output end coupled to the control end of the first transistor and the control end of the third transistor;
a first resistor including:
a first end coupled to the second end of the second transistor; and
a second end coupled to the first input end of the comparator;
a second resistor including:
a first end coupled to the second input end of the comparator; and
a second end coupled to the first end of the third transistor;
a first variable capacitor including:
a first end coupled to the second end of the second transistor; and
a second end coupled to the second input end of the comparator;
a second variable capacitor including:
a first end coupled to the first input end of the comparator; and
a second end coupled to the first end of the third transistor;
a first inverter coupled between the first output end of the comparator and a first output of the crystal-less signal synthesizer; and
a second inverter coupled between the second output end of the comparator and a second output of the crystal-less signal synthesizer.
